(19) United States
(12) Patent Application Publication
(10) Pub. No.: US 2025/0209466 A1
(43) Pub. Date: Jun. 26, 2025

(54) 32-Dimensional Financial Security and Risk Control System

(71) Applicant: FURONG BEI, SAN GABRIEL, CA (US)

(72) Inventor: FURONG BEI, SAN GABRIEL, CA (US)

(21) Appl. No.: 19/074,355

(22) Filed: Mar. 8, 2025

(51) Int. Cl. G06Q 20/40

(52) U.S. Cl. CPC G06Q 20/4016

(57) ABSTRACT

This invention introduces a 32-dimensional financial security and risk control system designed to address advanced cyber threats and ensure comprehensive protection for financial platforms. It integrates multi-layered encryption, AI-based dynamic risk control, virtual wormholes, and a hive network architecture to secure data transmission, identity verification, and transaction integrity. The system employs smart contracts and AI models to dynamically adjust risk parameters and execute risk mitigation strategies, providing an adaptive and highly secure financial infrastructure.

### TECHNICAL FIELD

The present invention relates to financial security systems, more specifically to a 32-dimensional architecture-based financial security and risk control system designed to ensure high-level security in data transmission, storage, transaction integrity, and identity verification for decentralized and centralized financial platforms.

### BACKGROUND OF THE INVENTION

With the rapid development of decentralized finance (DeFi) and the increasing threats of cyber-attacks, ensuring financial security and risk control has become a paramount concern. Traditional security systems often rely on limited-dimensional approaches, focusing on encryption and access control. However, these methods are insufficient to counteract advanced persistent threats (APTs), multi-vector attacks, and insider threats.

To address these challenges, there is a need for a comprehensive, multi-dimensional security and risk control system capable of providing layered and adaptive protection across all aspects of financial operations.

### SUMMARY OF THE INVENTION

This invention introduces a 32-dimensional financial security and risk control system (hereinafter referred to as “the System”). The System is designed to provide comprehensive protection by integrating encryption, isolation, redundancy, backup, AI-based risk control models, and virtual wormhole and hive architecture. It aims to prevent hacking attempts, data breaches, and other cyber threats.

### Key Features:

1. 32-Dimensional Security Architecture: Incorporates multiple dimensions of security, including data transmission, storage, identity authentication, transaction integrity, and AI-based threat detection.
2. Virtual Wormhole and Hive Network Architecture: Ensures secure data transmission and isolation to mitigate risks of network attacks.
3. AI-Powered Dynamic Risk Control: Utilizes AI models to analyze, predict, and mitigate risks in real-time.
4. Smart Contracts and Layered Strategies: Enables automated execution of risk control measures based on predefined conditions.
5. Encryption and Redundancy: Integrates multi-layered encryption protocols, data redundancy, and secure backup mechanisms.

### DETAILED DESCRIPTION OF THE INVENTION

### 1. 32-Dimensional Security Architecture

Encryption: Utilizes multi-layer encryption protocols for data in transit and at rest.
Isolation: Implements network and application layer isolation to prevent lateral movement in case of a breach.
Redundancy: Ensures multiple data paths and storage redundancy to safeguard against failures.
Backup: Provides decentralized and centralized backup strategies for data recovery.
Access Control: Employs biometric, multi-factor authentication, and role-based access control (RBAC).
Integrity Checks: Uses hash-based and AI-powered integrity checks for data and transactions.
Anomaly Detection: Integrates AI algorithms to identify deviations from normal behavior in real-time.
Compliance Monitoring: Continuously checks compliance with financial regulations using smart contracts.

### 2. Virtual Wormhole and Hive Network Architecture

Virtual Wormholes: Establishes secure, encrypted tunnels for data transmission, preventing interception and tampering.
Hive Network: Adopts a honeycomb architecture for multi-layered and interconnected security nodes, enabling adaptive security measures across all layers.

### 3. AI-Powered Dynamic Risk Control

AI Models: Utilizes supervised, unsupervised, and reinforcement learning models to detect patterns indicative of fraud or risks.
Real-time Analysis: Processes large volumes of transactions instantly to flag suspicious activities.
Automated Response: Activates smart contracts to execute pre-defined risk mitigation actions, such as freezing transactions or initiating alerts.

### 4. Smart Contracts and Layered Strategies

Multi-Signature Mechanism: Requires multiple approvals for high-risk transactions.
Weighted Voting System: Implements a governance model where decision-making power is distributed based on weighted tokens.
Dynamic Risk Thresholds: Adjusts risk parameters in real-time based on market conditions and AI analysis.

### 5. Encryption and Redundancy

Quantum-Resistant Encryption: Prepares the system against future quantum computing threats.
Data Sharding: Splits sensitive data into fragments stored across different nodes to prevent unauthorized access.

### BRIEF DESCRIPTION OF THE DRAWINGS

FIG. 1: 32-Dimensional Security Architecture-Illustrates various layers of security including encryption, isolation, redundancy, and AI-based threat detection.

FIG. 2: Virtual Wormhole and Hive Network-Demonstrates data transmission and interconnection of nodes through virtual wormholes and hive architecture.

FIG. 3: AI-Powered Risk Control Flow-Depicts how AI models detect, analyze, and respond to threats dynamically.

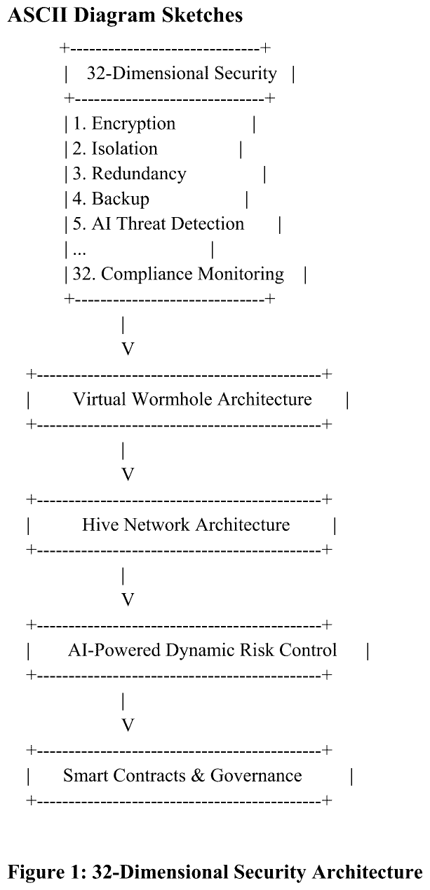

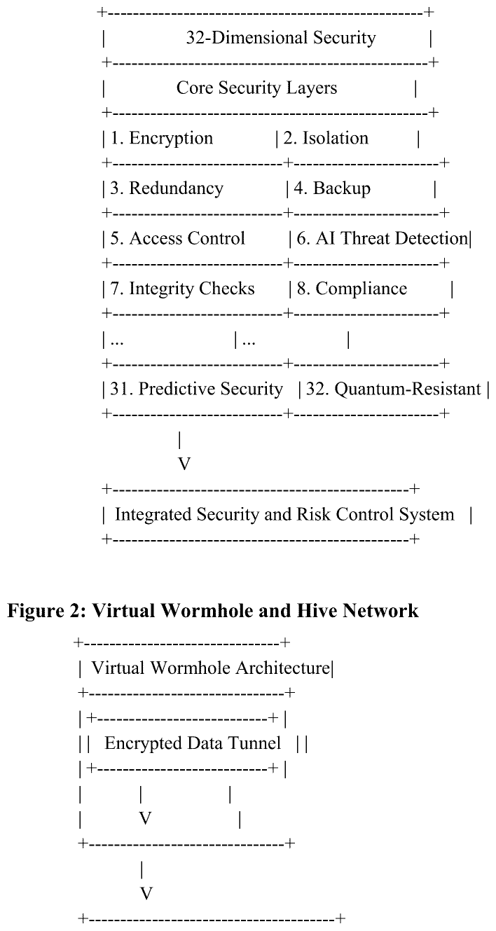

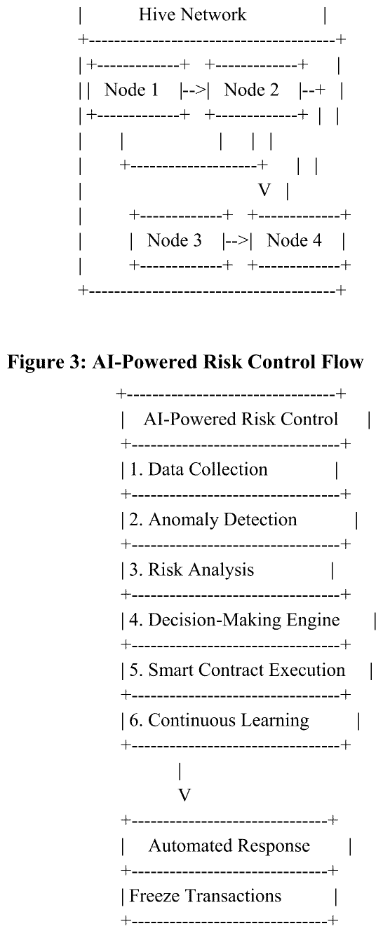

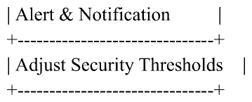

1: 32-Dimensional Security System
A 32-dimensional financial security system comprising:
A multi-layered encryption protocol for both data in transit and at rest, ensuring confidentiality and protection against unauthorized access.
An isolation mechanism that prevents lateral movement of threats across different network layers.
Redundancy measures including mirrored databases and multiple data pathways to guarantee data availability and integrity.
Backup solutions incorporating both decentralized and centralized strategies for secure data recovery.
Access control mechanisms including biometric authentication, multi-factor authentication (MFA), and role-based access control (RBAC).
AI-based anomaly detection modules designed to identify and flag suspicious activities in real-time.
Compliance monitoring mechanisms utilizing smart contracts to enforce regulatory requirements dynamically.

2: Virtual Wormhole Architecture
A virtual wormhole architecture within the 32-dimensional security system, comprising:
Encrypted data tunnels designed to prevent interception and tampering of sensitive information during transmission.
Dynamic routing protocols that adapt paths based on threat analysis to minimize exposure to potential attacks.
Integration with hive network architecture to distribute and isolate traffic, reducing the risk of single-point failures.

3: Hive Network Architecture
A hive network architecture implemented in the 32-dimensional security system, comprising:
A honeycomb-like structure of interconnected security nodes, each independently capable of threat detection and response.
Multi-layered defenses within each node, including encryption, isolation, and AI-based risk assessment.
Scalability features allowing for the addition of new nodes without compromising overall security or efficiency.
Automated communication between nodes using encrypted protocols to ensure real-time sharing of threat intelligence.

4: AI-Powered Dynamic Risk Control System
An AI-powered dynamic risk control system within the 32-dimensional security architecture, comprising:
AI models trained using supervised, unsupervised, and reinforcement learning techniques to identify and predict potential risks.
Real-time data analysis capabilities to detect anomalies and trigger automated responses.
Integration with smart contracts to execute predefined risk mitigation actions, such as freezing suspicious transactions or triggering alerts.
Adaptive learning modules that continuously update AI algorithms based on new threat intelligence.

5: Smart Contract-Based Risk Mitigation
A smart contract-based risk mitigation mechanism, comprising:
Multi-signature approval requirements for executing high-risk transactions, ensuring consensus-based execution.
Weighted voting systems based on token holdings to implement governance decisions on risk thresholds.
Automated execution of risk mitigation strategies, including transaction reversals, security alerts, and data encryption.

6: Quantum-Resistant Encryption Protocols
A quantum-resistant encryption mechanism integrated within the 32-dimensional security system, comprising:
Lattice-based and hash-based encryption protocols designed to withstand quantum computing attacks.
Layered encryption with both classical and post-quantum cryptographic algorithms for data in transit and at rest.
Automated key rotation and management system to minimize vulnerabilities.

7: Multi-Layered Access Control System
A multi-layered access control system, comprising:
Role-based access control (RBAC) integrated with biometric authentication for sensitive operations.
AI-powered access monitoring to detect and block unauthorized access attempts dynamically.
Time-based access control to limit access to critical resources based on predefined schedules.

8: Predictive Threat Intelligence System
A predictive threat intelligence system within the 32-dimensional security architecture, comprising:
AI algorithms trained to recognize patterns indicative of emerging threats based on historical and real-time data.
Automated threat scoring system to categorize and prioritize risks.
Integration with hive network architecture to distribute threat intelligence across all security nodes.

9: Compliance Enforcement via Smart Contracts
A compliance enforcement system using smart contracts, comprising:
Automated monitoring of financial transactions to ensure adherence to regulatory requirements.
Smart contracts programmed to halt non-compliant transactions and generate compliance reports.
Continuous auditing features integrated with AI-powered analysis to detect potential compliance breaches.

10: Data Sharding and Fragmentation for Enhanced Security
A data sharding and fragmentation mechanism, comprising:
Automated data fragmentation into smaller, encrypted shards distributed across multiple nodes.
Access control mechanisms that require multi-factor authentication for reassembling and accessing full datasets.
Redundant storage of shards across decentralized nodes to prevent data loss or corruption.

11: Anomaly Detection and Automated Response System
An anomaly detection and automated response system, comprising:
AI models utilizing deep learning techniques to detect deviations from normal network behavior.
Automated responses triggered by detected anomalies, including IP blocking, access revocation, and transaction suspension.
Continuous feedback loop for AI models to improve detection accuracy based on real-time data.

12: Multi-Signature Transaction Verification System
A multi-signature transaction verification system, comprising:
Requirement of multiple private keys for approving and executing high-value transactions.
Integration with smart contracts to automate multi-signature validation processes.
Time-lock features to allow delayed execution of transactions for additional security.

13: Decentralized Backup and Recovery System
A decentralized backup and recovery system, comprising:
Utilization of blockchain-based storage solutions for storing backup data across multiple nodes.
Encrypted backup protocols ensuring data privacy during storage and transmission.
Automated recovery mechanisms that verify data integrity before restoring backups.

14: Adaptive Security Thresholds
A system for adaptive security thresholds, comprising:
AI algorithms that dynamically adjust security thresholds based on real-time risk assessment.
Integration with smart contracts to enforce adjusted thresholds without manual intervention.
Continuous monitoring and feedback to optimize threshold settings based on evolving threats.

15: End-to-End Data Integrity Verification
An end-to-end data integrity verification system, comprising:
Hash-based verification mechanisms for ensuring data integrity during transmission and storage.
AI-based detection of data tampering and unauthorized modifications.
Automated alerts and corrective actions upon detection of integrity breaches.

16: Automated Governance and Decision-Making System
An automated governance and decision-making system, comprising:
Smart contracts implementing governance rules based on weighted token voting.
AI-based analysis of governance proposals to assess risk and compliance implications.
Automated execution of governance decisions based on predefined thresholds.

17: Intelligent Routing for Secure Data Transmission
An intelligent routing system for secure data transmission, comprising:
AI algorithms that determine optimal data transmission paths based on real-time threat intelligence.
Use of virtual wormholes to secure data packets during transmission.
Automated rerouting capabilities in response to detected threats or network anomalies.

18: Biometric and AI-Based Authentication Mechanism
A biometric and AI-based authentication mechanism, comprising:
Multi-factor authentication utilizing biometric data and AI-based behavioral analysis.
Continuous authentication systems that verify user identity throughout a session.
Automated access revocation upon detection of anomalies or compromised credentials.

19: Continuous AI-Driven Security Audit System
A continuous security audit system driven by AI, comprising:
AI algorithms that perform real-time security audits of financial transactions and network activities.
Automated reporting of audit findings and compliance status.
Integration with smart contracts for immediate execution of remediation actions.

20: Dynamic Key Management System
A dynamic key management system for encryption, comprising:
Automated generation and rotation of encryption keys based on risk levels.
AI-based analysis of key usage patterns to detect potential compromises.
Multi-factor authentication for key access and decryption operations.
